(19) United States
(12) Patent Application Publication
(10) Pub. No.: US 2015/0162622 A1
(43) Pub. Date: Jun. 11, 2015

(54) LARGE-SURFACE-AREA, UNSUPPORTED CATALYST FOR ELECTRO-CHEMICAL PROCESSES AND METHOD FOR PRODUCING SAME

(71) Applicants: PAUL SCHERRER INSTITUT, VILLIGEN PSI (CH); TECHNISCHE UNIVERSITAET DRESDEN, DRESDEN (DE)

(72) Inventors: Alexander Eychmueller, Dresden (DE); Annette Foelske-Schmitz, Koblenz (CH); Nikolai Gaponik, Dresden (DE); Anne-Kristin Herrmann, Dresden (DE); Ruediger Koetz, Gippingen (CH); Wei Liu, Zuerich (CH); Annette Rabis, Urdorf (CH); Perez Paramaconi Benito Rodriguez, Untersiggenthal (CH); Thomas Justus Schmidt, Wuerenlingen (CH); Jipei Yuan, Huguan (CN)

(21) Appl. No.: 14/417,212

(22) PCT Filed: Jun. 10, 2013
(86) PCT No.: PCT/EP2013/061922

§ 371 Date: Jan. 26, 2015

(30) Foreign Application Priority Data
Jul. 25, 2012 (EP) 12177908.6
Oct. 16, 2012 (EP) 12188717.8

(51) Int. Cl. H01M 4/90; H01M 12/08; C25B 11/04; H01M 4/92

(52) U.S. Cl. CPC H01M 4/9041; H01M 4/92; H01M 12/08; C25B 11/04; H01M 4/921

(57) ABSTRACT

A catalyst is to avoid the corrosion of a support and still have an active surface area of more than 30 m²/gmetal, preferably more than 50 m²/gmetal, particularly preferably more than 70 m²/gmetal. It has a high dispersion, achieving high stability and high activity (selectivity). A large-surface-area, unsupported catalyst has at least one metal for electrochemical processes, and a BET surface area of at least 30 m²/g, preferably more than 50 m²/g. The BET surface area is achieved by an arrangement of the at least one metal formed as a metal aerogel. Metal aerogels are produced in this manner. Metal aerogels, or metallic polymers, are fine-structured, inorganic superlattices having high porosity. In these metallic polymers, ince individual particles in the nanometer range typically are crosslinked with each other and form the highly porous network structures.

The invention relates to novel unsupported large-surface-area catalysts composed of metals for electrochemical processes and methods for producing the same.

Catalysts for electrochemical reactions often employ metals of the platinum group or other noble metals. Alloys of platinum group metals with other platinum group metals or other transition metals are also often used. Examples include nickel, cobalt, vanadium, iron, titanium, copper, ruthenium, palladium, iridium, gold etc. Such catalysts are used in particular in fuel cells, electrolyzers and metal-air batteries. The catalysts may be used both on the anode and on the cathode. In all of these applications the catalysts need to be highly stable to corrosion, especially in fuel cell cathodes, electrolyzer anodes and the air side of metal-air batteries.

The catalysts are typically applied to a support in order that a very large active catalyst surface area of more than 70 m²/g may be achieved. Fuel cells for example typically employ carbon as this support. The carbons employed have typical specific BET surface areas of up to 1000 m²/g in order that the catalyst particles may be very finely divided, thus increasing the active catalyst surface area. The disadvantage of customary supports, for example Vulcan XC 72 (from Cabot) having a BET surface area of about 250 m²/g or Ketjen Black EC-300 (from Akzo-Nobel) having a BET surface area of about 800 m²/g, is that they corrode very rapidly, i.e., they are very rapidly oxidized to CO₂ under operating conditions, thus impairing the functionability of the electrode which then leads to failure of the electrochemical system such as the fuel cell.

It is possible to define in general terms a good and functionable electrocatalyst having a large active surface area and a support which can undergo only little, if any, corrosion.

One way to stabilize catalyst supports is to graphitize the large-surface-area carbon supports which typically does enhance the corrosion resistance thereof but does not prevent the intrinsic instability. Alternatively, unsupported catalysts may be employed which naturally prevents catalyst support problems. However, unsupported systems are always associated with a reduction in catalyst dispersion, i.e., the active catalyst surface area is reduced from more than 70 m²/g for supported systems to approximately no more than 20 m²/g for Pt-black catalysts for example. This means that, for a fuel cell for example, the catalyst loading needs to be increased by a factor equal to the reduction in surface area in order to achieve the same electrochemical performance. This consequently leads to higher costs, especially when the catalysts are platinum group metals. A commercially available system is made by 3M for example. Here, catalysts such as Pt or metal alloys are applied to specific organic nonconducting substrates by vaporization or sputtering which although corresponding to an unsupported catalyst system only achieves specific surface areas of no more than 20 m²/gₘₑₜₐₗ. These so-called expanded metal surfaces are notable for their very high stability but, as mentioned hereinabove, are characterized by a low dispersion (surface-to-bulk ratio) which significantly reduces the utilization of the catalyst employed since all electrochemical reactions take place on the catalyst surface.

The present invention has for its purpose to provide a catalyst system which avoids corrosion of the support while nonetheless having an active surface area of more than 70 m² /gₘₑₜₐₗ i.e. a high dispersion, in order thus to achieve both high stability and high activity (selectivity).

This purpose is achieved in accordance with the present invention by an unsupported large-surface-area catalyst composed of at least one metal for electrochemical processes which has a BET surface area of at least 30 m²/g, preferably more than 50 m²/g, wherein this BET surface area is achieved by the arrangement of the at least one metal in a metal aerogel structure.

It is further an object of the present invention to specify a method for producing such a catalyst.

This object is achieved in accordance with the invention by a method for producing a catalyst, in particular a catalyst of the abovementioned type, comprising the steps of:

a) providing an aqueous or organic metal salt solution;

b) adding an aqueous or organic reducing agent, in particular an aqueous sodium borohydrate solution;

c) allowing the aqueous or organic mixture to stand to form a metal hydrogel;

d) washing the metal hydrogel with water and adding acetone;

e) removing the water to obtain an acetone-containing metal hydrogel;

f) introducing the acetone-containing metal hydrogel into a dryer and exchanging the acetone for liquid carbon dioxide; and

g) transferring the carbon dioxide into the gas phase by elevating the temperature of the carbon dioxide-containing metal hydrogel above the critical point of carbon dioxide and decompressing and releasing the carbon dioxide transferred into the gas phase. As an alternative to step g), drying of the liquid carbon dioxide may also be effected by freeze-drying, vacuum-drying or other commonly used drying methods.

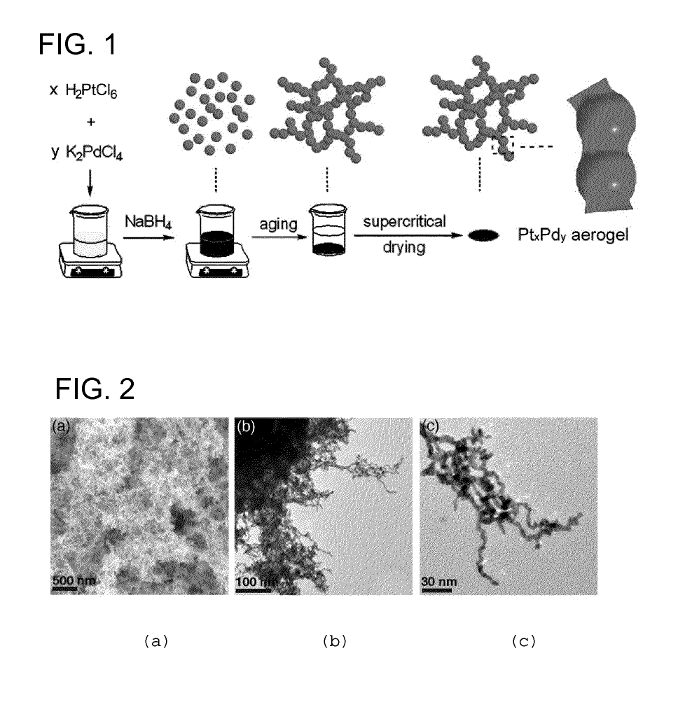

This is how so-called metal aerogels are produced here in accordance with the invention. FIG. 1 is a schematic diagram of this production method. With the aid of an SEM image (a) and two TEM images (b) and (c), FIG. 2 shows that the metal aerogels according to the invention form filigree inorganic superstructures which are highly porous on a micro- and nanoscale. Such aerogels are also known as metallic polymers since, typically, individual particles are crosslinked with one another on a nanometer scale to form said highly porous network structures. One characteristic of aerogels is the high porosity of the network of nanostructures combined with the thus significantly reduced density compared to the bulk materials (up to 1000 times lower density compared to the bulk material).

Inorganic aerogels, especially of silicon dioxide, aluminium oxide, or aerogels of carbon are known per se and are employed in many areas of gas-phase catalysis as support material for the active phase. The production of unsupported metal aerogels too was recently reported (Angew. Chemie 2009, 121, 9911) with silver as crosslinking material. However, the bimetallic aerogel mixtures described therein (Ag/Pt, Ag/Au) always comprise silver which acts as crosslinking material in the process described. The aerogels are moreover produced (Angew. Chemie 2009, 121, 9911) using a stabilizer, for example dextrins, which require laborious removal after the synthesis or else remain and can poison the catalyst.

One characteristic of aerogels is specific surface area, also known as BET surface area. BET surface area is typically determined by adsorption and desorption of N₂. The bimetallic aerogels described in Angew. Chemie 2009, 121, 9911 have BET surface areas of less than 50 m²/g. The monometallic aerogels according to the invention have surface areas of at least 30 m²/g, preferably surface areas of 50 m²/g and more preferably of 70 m²/g or more.

While Angew. Chemie 2009, 121, 9911 describes only unalloyed bimetallic aerogels, the bi- or trimetallic aerogels according to the invention are defined alloys. The bi- or trimetallic aerogels according to the invention have surface areas of at least 30 m²/g, preferably surface areas of 50 m²/g and more preferably of at least 70 m²/g or more.

The formation of alloys may typically be determined by X-ray diffraction since in multimetallic systems too only one reflection per orientation is detected, indicating the formation of only one phase, while unalloyed systems exhibit a plurality of reflections per orientation, indicating multiphase formation.

Surprisingly, both the monometallic aerogels and the alloyed multimetallic aerogels exhibit enhanced catalytic activity compared to supported systems, for example Pt on carbon, especially for reactions occurring in fuel cells, electrolyzers and metal-air batteries.

Electrochemical activity may be determined using measurements taken with a rotating disk electrode in 0.1 M HClO₄ or 0.1 M KOH. The catalyst to be analyzed is applied to a glassy carbon disk of 5 mm in diameter. Depending on the catalyst, catalyst loading is typically between 10 and 40 μg/cm². The desired reaction is accordingly carried out in reactant-saturated electrolyte. For the reduction of oxygen, the activity is the quotient of the product and the difference between the limiting diffusion current and the measured current at 0.9 V and the result is the electrochemical activity of the catalyst for the reduction of oxygen. The activities for other reactions may be determined in similar fashion, for example the activity for O₂ evolution, H₂ evolution etc.

Surprisingly, both the monometallic aerogels and the alloyed multimetallic aerogels exhibit enhanced corrosion stability compared to supported systems, e.g. Pt on carbon.

Corrosion stability is likewise determined using a rotating disk electrode. The catalyst to be analyzed is applied to a glassy carbon disk of 5 mm in diameter. Depending on the catalyst, the catalyst loading is typically between 10 and 40 μg/cm². Determining corrosion stability comprises determining, for example, the oxygen reduction or evolution activity as described hereinabove before cycling the electrode 8000 times between electrochemical potentials between 0.5 V and 1.0 V. The activity is then determined again in similar fashion. Enhanced stability may now be inferred directly from enhanced activity. Corrosion stability is further determined potentiostatically by holding the abovementioned electrodes at 1.5 V over a period of several hours and determining the activity before and after the test.

The catalytically active material of the unsupported aerogels according to the invention is Pt, Pd, Au, Ir, Ru, Rh, Os, Cu, Ni, Co, Fe, Mn. Especially preferred metals are Pt, Pd, Au, Ir, Ru, Ag, Rh, Os, Cu, Ni, particular preference being given to Pt, Pd, Au, Ir, Ru, Cu. The active material according to the invention is further an alloy of the above with one or more metals selected from the transition and main groups. Alloys useful specifically as cathode catalyst in fuel cells include but are not limited to alloys of Pt with Ni, Co, Fe, Mn, Pd.

The catalysts according to the invention are employed, for example, as electrode catalyst and preferably as cathode catalyst. The catalyst is particularly useful as electrode catalyst in fuel cells, particularly on the cathode side. The catalysts according to the invention are further employed as anode catalysts in electrolyzers, particularly as anode catalysts for electrolysis of water. The catalysts according to the invention are further employed as cathode catalysts in electrolyzers, particularly for forming hydrogen and for reducing carbonaceous compounds. The catalysts according to the invention are further employed in air electrodes, particularly in air electrodes of Li-air batteries and Zn-air batteries but also in other metal-air batteries.

### EXAMPLE 1

### Synthesis of PtPd Alloy Aerogels

a) Pt:Pd Ratio of 1:1

396 mL of an aqueous solution of 0.1 mM K₂PdCl₄/0.1 mM H₂PtCl₆ are stirred for 10 min and 4.5 mL of a freshly prepared 40 mM aqueous NaBH₄ solution are then added. This changes the color of the solution from light yellow to dark gray. The solution is subsequently stirred for a further 30 min and left to stand for a further three days. After three days, a black PtPd hydrogel of composition 1:1 is formed. The hydrogel is washed with water 6-8 times and acetone is then added dropwise to displace the water. The acetone-containing hydrogel is placed in a desiccator under vacuum for one day to remove any water present. This procedure is repeated twice. The water-free acetone-containing gel obtained is transferred into a critical point dryer and the acetone is exchanged for liquid CO₂ (5 minutes). The vessel remains sealed overnight and the purging with liquid CO₂ is repeated before the temperature of the sample exceeds the critical point of CO₂ to allow the CO₂ to pass into the gas phase. The gas is then slowly decompressed and released to obtain the PtPd aerogel of composition 1:1.

b) Pt:Pd Ratio of 4:1

396 mL of an aqueous solution of 0.04 mM K₂PdCl₄/0.16 mM H₂PtCl₆ are stirred for 10 min and 4.5 mL of a freshly prepared 49 mM aqueous NaBH₄ solution are then added. Performing the steps described in a) affords a PtPd aerogel of composition 4:1.

c) Pt:Pd Ratio of 1:4

396 mL of an aqueous solution of 0.16 mM K₂PdCl₄/0.04 mM H₂PtCl₆ are stirred for 10 min and 4.5 mL of a freshly prepared 32 mM aqueous NaBH₄ solution are then added. Performing the steps described in a) affords a PtPd aerogel of composition 1:4.

### EXAMPLE 2

### Pd Aerogel Synthesis

396 mL of an aqueous solution of 0.2 mM K₂PdCl₄ are stirred for 10 min and 4.5 mL of a freshly prepared 27 mM aqueous NaBH₄ solution are added. The further steps of the process are similar to Example 1a) except that the formation time is increased to 17 days. A pure Pd aerogel is obtained.

### EXAMPLE 3

### Pt Aerogel Synthesis

396 mL of an aqueous solution of 0.2 mM H₂PtCl₆ are stirred for 10 min and 4.5 mL of a freshly prepared 27 mM aqueous NaBH₄ solution are added. The further steps of the process are similar to Example 1a). A pure Pt aerogel is obtained.

### EXAMPLE 4

a) Determining BET Surface Areas

The specific surface area of the different metal aerogels are determined by measuring N₂ adsorption (so-called BET surface area) at 77 K (Quantachrome Autosorb 1). 40 mg of the aerogel are transferred into the measuring cell and degassed under vacuum at 323 K overnight. The specific surface area is determined by solving a multipoint BET equation (0.05<p/po<0.2). The results are shown in the table for Example 4a. It is apparent that the catalysts according to the invention have a BET surface area of more than 70 m²/g.

Table for Example 4a

| Aerogel composition | BET metal surface area [m²/gₘₑₜₐₗ] |
|---|---|
| PtPd (1:1) | 86 |
| PtPd (4:1) | 126 |
| PtPd (1:4) | 75 |
| Pd | 125 |
| Pt | 133 |

b) X-Ray Diffraction Measurement for Determining Alloying

X-ray diffraction measurements are taken for determining alloying in the PtPd aerogels. To determine whether alloys are present, the reflections for alloys appear between the reflections for pure metals as a function of composition. The table for Example 4b shows the position of the (111) reflections as a function of alloy composition. The shift in the reflections as a function of aerogel composition is indicative of alloy formation.

Table for Example 4b

| Aerogel composition | (111) reflection position in 2Θ [°] |
|---|---|
| Pt | 39.072 |
| PtPd 4:1 | 39.525 |
| PtPd 1:1 | 39.719 |
| Pd | 39.935 |

c) Composition of the Alloys

The composition of the aerogels is determined by energy-dispersive X-ray spectroscopy (EDS). This comprises transferring a sample of the aerogels into a Zeiss DSM 982 Gemini instrument. The EDS data are measured with three iterations at a magnification of 5000, an acceleration voltage of 9 kV and an angle of 35°. The results are shown in the table for Example 4c.

Table for Example 4c

| Aerogels | Pt (%) | Pd (%) |
|---|---|---|
| Pd | 0 | 100 |
| PtPd 1:4 | 17.3 | 82.7 |
| PtPd 1:1 | 47.8 | 52.2 |
| PtPd 4:1 | 77.5 | 22.5 |
| Pt | 100 | 0 |

### EXAMPLE 5

### Determining Electrochemically Active Surface Area of Pt Aerogels, Pd Aerogels and Commercial 20% Pt/Vulcan XC72 (ETEK-BASF Fuel Cell GmbH)

The electrochemically active metal surface area of the Pt aerogel is determined by cyclic voltammetry. This comprises applying a thin layer of the aerogel from a suspension onto a glassy carbon electrode of surface area 0.196 cm² to obtain a loading of 2.25 μg_{Pt}. The so-called hydrogen underpotential deposition in 0.1 M HClO₄ solution is then used to determine the specific electrochemical surface area. The region between 0.05 V and 0.45 V in a cyclic voltammogram is integrated, the double layer capacitance is subtracted and the surface area is then calculated. A typical charge of 0.210 mC per cm² of actual electrochemical surface area is used as a base value. For comparison, the surface area of a supported industrial fuel cell catalyst from ETEK-BASF Fuel Cell GmbH and often used in fuel cells is measured in the same way. The Pt loading of the supported system is 44 μg_{Pt}/cm². It is apparent that the aerogels according to the invention have a distinctly larger specific electrochemical surface area compared to the supported system.

Pt aerogel: 20% Pt/Vulcan XC72: 49 m²/gpₜ

Pt aerogel produced as per Example 2: 92 m²/gpₜ

Pd aerogel produced as per Example 3: 95 m²/gpₜ

### EXAMPLE 6

### Determining Oxygen Reduction Activity of Pt Aerogel, PtPd Aerogel and 20% Pt/Vulcan

The oxygen reduction reaction (ORR) activity is determined using measurements taken with a rotating disk electrode. This comprises preparing the electrodes as is described in Example 5 and taking measurements in O₂-saturated 0.1 M HClO₄ electrolyte at a rotation rate of 1600 rpm and a potential scanning rate of 10 mV/s at 25° C. The cathodic curves obtained are IR corrected (corrected for electrolyte ohmic resistance) and the oxygen reduction current density at 0.9 V is determined. Both the surface area-specific current density and the mass-specific current density are calculated and compared with the activity of a supported industrial fuel cell catalyst from ETEK-BASF Fuel Cell which is often used in fuel cells.

The results are shown in the table for Examples 6/7. While the area-specific activities of the Pt/Vulcan XC 72 catalyst and the Pt aerogel catalyst according to the invention are similar, the mass-specific activity of the aerogel catalyst according to the invention is distinctly enhanced.

### EXAMPLE 7

### Determining Corrosion Stability of the Aerogels and Pt/Vulcan

The corrosion stability of the catalysts according to the invention is determined by extensive potential cycling.

Cycle 1: Lifecycle of a fuel cell.

This comprises cycling the electrode between potentials of 0.5 V and 1.0 V in 0.1 M HClO₄ at room temperature and a potential scan rate of 50 mV/s and determining the oxygen activity as described hereinabove after 8000 cycles. This cycle is used to determine the stability of the nanoparticles and the aerogels. It is apparent that both Pt/C and the Pt aerogel exhibit the same activity after 8000 potential cycles. Under these conditions, the alloy aerogels exhibit only insignificant degradation or even improved performance.

Corrosion test (determined for the catalysts comprising exclusively Pt): This comprises holding the electrodes comprising the catalysts according to the invention at 1.5 V for 5 hours and determining the oxygen reduction activity before and after the potentiostatic measurement. The table for Examples 6/7 shows the reduction in activity after the test as a percentage of the initial value. It is apparent that the aerogel catalyst exhibits reduced degradation compared to the commercial supported Pt/Vulcan XC72 catalyst.

The electrodes employed are prepared as described in Example 5. The data obtained are shown in the table for Examples 6/7 which follows.

| | | | Mass- | Reduction | Reduction |
|---|---|---|---|---|---|
| | | Mass- | specific | in mass- | in mass- |
| | Area- | specific | ORR activity | specific | specific |
| | specific | ORR | at 0.9 V | ORR | ORR |
| | ORR | activity | [mA/mgₘₑₜₐₗ] | activity at | activity at |
| | activity at | at 0.9 V | after | 0.9 V after | 0.9 V after |
| | 0.9 V | [mA/ | potential | potential | corrosion |
| Catalyst | [mA/cm²ₘₑₜₐₗ] | mgₘₑₜₐₗ] | cycle 1 | cycle 1 [%] | test [%] |
| PtPd (1:1) | not | 1000 | not | — | not |
| aerogel | determinable | | determined | | determined |
| PtPd (4:1) | not | 1130 | 920 | −19 | not |
| aerogel | determinable | | | | determined |
| PtPd (1:4) | not | 270 | not | — | not |
| aerogel | determinable | | determined | | determined |
| PtPd (3:2) | not | 430 | 670 | +55 | not |
| aerogel | determinable | | | | determined |
| Pd aerogel | 0.10 | 66 | 25 | −62 | not |
| | | | | | determined |
| Pt aerogel | 0.39 | 355 | 135 | −62 | −30 |
| 20% | 0.43 | 225 | 131 | −42 | −75 |
| Pt/Vulcan | | | | | |

1-8. (canceled)

9. An unsupported large-surface-area catalyst composed of at least one metal for electrochemical processes, comprising:
an aerogel structure formed of the at least one metal; and
the aerogel structure being a catalyst having a BET surface area of at least 30 m²/g.

10. The catalyst according to claim 9, wherein said BET surface area is greater than 50 m²/g.

11. The catalyst according to claim 9, wherein said aerogel structure comprises an alloy of two or more metals in aerogel form.

12. The catalyst according to claim 9, wherein the metal is at least one metal selected from the group consisting of Pt, Pd, Au, Ir, Ru, Rh, Os, Cu, Ni, Co, Fe and Mn.

13. The catalyst according to claim 9, wherein the metal is at least one metal selected from the group consisting of Pt, Pd, Au, Ir, Ru, Rh, Cu and Ni.

14. The catalyst according to claim 9, wherein the metal is at least one metal selected from the group consisting of Pt, Pd, Au, Ir, Ru, Ni and Cu.

15. The catalyst according to claim 12, wherein the catalyst has an active material being an alloy of one or more of the said metals of the group with one or more metals selected from the transition and main groups.

16. A method for producing a catalyst, the method comprising the following steps:
a) providing an aqueous or organic metal salt solution;
b) adding an aqueous or organic sodium borohydrate solution;
c) allowing the aqueous or organic mixture to stand to form a metal hydrogel;
d) washing the metal hydrogel with water and adding acetone;
e) removing the water to obtain an acetone-containing metal hydrogel;
f) introducing the acetone-containing metal hydrogel into a dryer and exchanging the acetone for liquid carbon dioxide; and
g) transferring the carbon dioxide into gas phase by elevating a temperature of the carbon dioxide-containing metal hydrogel above a critical point of carbon dioxide and decompressing and releasing the carbon dioxide transferred into the gas phase.

17. The method according to claim 16, which comprises carrying out the step to produce a catalyst according to claim 9.

18. The catalyst according to claim 9 configured to form a constituent part of a fuel cell, a fuel cell electrode, a membrane-electrode assembly, or a catalyst layer.

19. An electrolyzer, comprising a catalyst according to claim 9 forming a constituent part of at least one of an electrode, a membrane-electrode assembly, and/or a catalyst layer of the electrolyzer.

20. A metal-air battery, comprising a catalyst according to claim 9 forming a constituent part of at least one of an electrode, a separator-electrode assembly, and/or a catalyst layer of the metal-air battery.

21. The metal-air battery according to claim 20, configured as a metal-oxygen battery.
